(19) United States
(12) Patent Application Publication
(10) Pub. No.: US 2007/0076592 A1
(43) Pub. Date: Apr. 5, 2007

(54) Non-invasive frequency rollback apparatus and method

(76) Inventors: Brian K. Thibeault, Attleboro, MA (US); Veronica M. Lobo, Sharon, MA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/241,569

(22) Filed: Sep. 30, 2005

(51) Int. Cl. H04J 3/14

(52) U.S. Cl. 370/217; 370/228

(57) ABSTRACT

A spare receiver in a CMTS is used to non-invasively test the signal quality of an original channel frequency of a receiver which has been tuned to another channel frequency so the operator can retune the receiver to its original channel frequency without disrupting subscriber operations. The spare receiver is RF connected to the receiver and performs RSSI testing on the channel frequency. If the channel frequency is sufficiently noise free, a modem is registered on the spare receiver as a testing modem. The testing modem is used to test the signal quality of the network, such as by using a SNR test. When the original channel frequency is determined to have a sufficient SNR value, the receiver is retuned to its original channel frequency.

### FIELD OF THE INVENTION

This invention relates to rolling back the frequency of a receiver in a network to a desired frequency. This invention more particularly relates to rolling back the frequency of a receiver in a network to a desired frequency without interruption of service to subscribers.

### BACKGROUND

Coaxial cable television systems have been in widespread use for many years and extensive networks have been developed. The extensive and complex networks are often difficult for a cable operator to manage and monitor. Particularly, a typical cable network generally contains a headend which provides content to a cable modem termination system (CMTS) containing several receivers, each receiver is usually connected to modems of many subscribers, e.g., a single receiver may be connected to hundreds of modems. In many instances the operator will cable multiple receivers together to serve a particular area of a town or city.

Cable networks are also increasingly carrying signals which require a high quality and reliability of service, such as voice communications or Voice over IP (VoIP) communications. Any disruption of voice or data traffic is a great inconvenience and often unacceptable to a subscriber. Various factors may affect the quality of service, including the quality of the upstream channels.

Cable operators often use Load Balancing Groups to equalize the load of the traffic across receivers, and Spectrum Groups to allocate multiple upstream frequencies to a receiver. In order to have receivers belong to the same Load Balancing Group or Spectrum Group they must be physically connected together. Multiple frequencies in a Spectrum Group may be used for frequency agility. The CMTS can determine which “backup” frequency is the best to use and retune the receiver in the Spectrum Group to the new frequency with no interruption to cable subscribers. Cable operators normally configure their active receivers to use frequencies that are in an area of the hybrid fiber co-axial network (HFC) spectrum that are usually clean, e.g. sufficiently free of noise which may otherwise interfere with communications on the frequency. In some HFC plants the cable operators sometimes have spare frequencies that are used as backups in case the original frequency does encounter noise.

Whenever the CMTS detects that the frequency a receiver is currently using has communication problems, such as having high noise levels, a cable operator (e.g., via spectrum management) may retune the receiver to another spare clean frequency, moving the receiver away from the problem frequency. Now the active channel is running on a clean frequency but not the one the operator prefers it to be on. The operator would rather have the active channel running on the original frequency of the receiver because the original frequency may be in a preferred location in the HFC spectrum. The process of going back to the original frequency is called rollback. However, the operator cannot simply retune the active receiver to the original frequency because it may still be noisy.

Currently an operator must simply randomly guess when to retune the receiver to the original frequency and hope that it is sufficiently noise free. The process of retuning the active receiver to the original frequency for testing often disrupts data passing on the receiver and especially voice (VoIP) data. Moreover, if the original frequency is still noisy, then further disruptions of service are likely to occur by using a noisy frequency, making disruptions to data and voice data even worse. If the original frequency is still noisy, the operator may need retune the receiver to spare frequency and try the rollback operation at a later time. This process of randomly guessed rollback may be performed multiple times.

There exists a need for an operator to determine when to perform a frequency rollback without disrupting service to subscribers.

### SUMMARY

This invention allows continuous monitoring of an original channel frequency of a receiver to allow an operator to retune the receiver to its original channel frequency without disruption of service to subscribers.

In accordance with the principles of the present invention, an apparatus for frequency rollback for receivers in a network having a plurality of receivers, each receiver being capable of receiving signals according to frequency channels from a plurality of modems, the apparatus may comprise: a switching unit which selectively connects a spare receiver to a signal line associated with one of the plurality of receivers, enabling the spare receiver to receive signals sent to a selected one of the plurality of receivers from a modem registered with the selected one of the plurality of receivers; and a controller configured to instruct the switching unit to connect the spare receiver with a communication line of a troubled receiver of the plurality of receivers which has been tuned to a frequency channel different than an original frequency channel of the troubled receiver, configured to tune a modem to the spare receiver as a testing modem, and configured to perform testing of the original frequency using the testing modem.

In the apparatus, the controller may further be configured to retune the troubled receiver back to its original frequency when the testing determines that the signal quality of the original frequency is sufficient.

In the apparatus, the controller may further be configured to perform receive signal strength indicator testing prior to tuning the testing modem to the spare receiver.

In the apparatus, the controller determines the signal quality of the original frequency without deregistering the testing modem.

In the apparatus, the signal quality of the original frequency is determined using a signal to noise ratio test.

In accordance with the principles of the invention, a method for performing a frequency rollback for receivers in a network having a plurality of receivers, each receiver being capable of receiving signals according to frequency channels from a plurality of modems, the method may comprise the steps of: connecting a spare receiver to a signal line associated with a troubled receiver which has been tuned to a different frequency than an original frequency of the troubled receiver; configuring the spare receiver to have a communication characteristics which correspond to communication characteristics of the troubled receiver; tuning the spare receiver to the original frequency of troubled receiver; testing a signal quality of the original frequency using the spare receiver; and retuning the troubled receiver to the original frequency when the signal quality of the original signal is determined to be suitable.

In the method, the step of testing the signal quality of the original frequency may include performing receive signal strength indicator testing by the spare receiver.

In the method, the step of testing the signal quality of the receiver includes the steps of: tuning a modem to communicate with the spare receiver; and performing testing on the original frequency using the modem and the spare receiver.

In the method, the testing performed by the modem and the spare receiver may be signal to noise ratio testing.

In accordance with the principles of the invention, a computer readable medium may contain instructions for a processor to perform a method of frequency rollback for receivers in a network having a plurality of receivers, each receiver being capable of receiving signals according to frequency channels from a plurality of modems, the method may comprise the steps of: connecting a spare receiver to a signal line associated with a troubled receiver which has been tuned to a different frequency than an original frequency of the troubled receiver; configuring the spare receiver to have a communication characteristics which correspond to communication characteristics of the troubled receiver; tuning the spare receiver to the original frequency of troubled receiver; testing a signal quality of the original frequency using the spare receiver; and retuning the troubled receiver to the original frequency when the signal quality of the original signal is determined to be suitable.

In the computer readable medium, the step of testing the signal quality of the original frequency may include performing receive signal strength indicator testing by the spare receiver.

In the computer readable medium, the step of testing the signal quality of the receiver includes the steps of: tuning a modem to communicate with the spare receiver; and performing testing on the original frequency using the modem and the spare receiver.

In the computer readable medium, the testing performed by the modem and the spare receiver may be signal to noise ratio testing.

Those of skill in the art will appreciate that the present invention enables cable operators to confidently return receivers to their intended frequencies without loss of service to subscribers, allowing the cable operators better management of their systems.

### BRIEF DESCRIPTION OF THE DRAWINGS

FIG. 1 illustrates an exemplary architecture of a CMTS in accordance with the principles of the invention.

FIG. 2 illustrates an exemplary configuration for connecting a spare receiver in an exemplary CMTS in accordance with the principles of the invention.

FIG. 3 illustrates an exemplary processing unit in accordance with the principles of the invention.

FIG. 4 illustrates an exemplary flow diagram of an exemplary process for rollback of a receiver to its original channel frequency according to the principles of the invention.

### DETAILED DESCRIPTION OF THE DRAWINGS

The spare receiver, or 9th receiver in an eight receiver unit, in accordance with the principles of the invention, allows continuous analysis of a receiver's original channel quality without disruption of voice (VoIP) or data traffic on the active receivers. When it is determined that the original channel is sufficiently clear of noise, the operator can confidently return the receiver to the original channel. In order to get the best analysis of the channel, the signal to noise ratio (SNR) metric may be used for testing, but those of skill in the art will appreciate that any appropriate testing technique may be used.

In the preferred implementation, a cable modem on the receiver (the testing modem) may be used to perform a variety of tests, such as SNR measurements. The testing can be performed without any loss of service for data or voice because the modem is on the spare receiver, and the testing does not affect any of the active receivers. The present invention enables the cable operator to be able to measure channel quality without time constraints or loss of service.

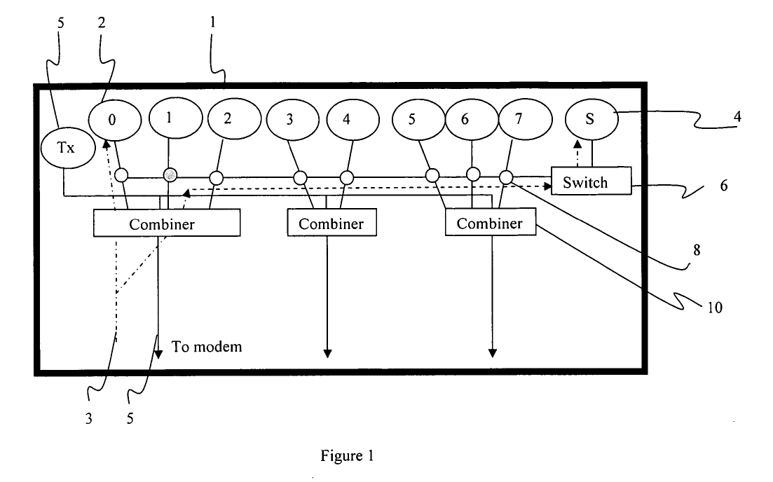

FIG. 1 illustrates an exemplary CMTS 1 with primary receivers 2 (R0-R7), which may be a Motorola BSR64000 CMTS. A transmitter unit 5 is also illustrated which serves to transmit signals to modems of the users (not shown) via signal path 5 and combiner 10. Transmitter unit 5 may be a single transmitter or multiple transmitters. Those of skill in the art will appreciate that transmitter unit 5 preferably transmits to the modems according to predetermined communication protocols, such as Data Over Cable Systems Interface Specification (DOCSIS) protocols.

While eight receivers are shown, those of skill in the art will appreciate that any number of receivers may be used. In the exemplary illustration, receivers R0, R1 and R2 are in one Load Balancing Group, receivers R3 and R4 are in another group and R5, R6 and R7 are in the last group. The spare receiver 4, illustrated as a 9^{th} receiver, can preferably tap into any one receiver R0-R7 at a time and, in the example of FIG. 1, is tapped into receiver 1 via tap 8. Combiner 10 receives signals from user modems and provides them to receivers 2 (R0-R7). Dotted line 3 depicts the return path that a response from a cable modem (not shown) to receiver R0 would take in the exemplary implementation of FIG. 1. Those of skill in the art will appreciate that the CMTS is used generally to refer to any suitable modem termination system, that the architecture illustrated is exemplary and any type of cabling (connections) may be used, such as coaxial wires, optical fibers, twisted pairs, and wireless connections.

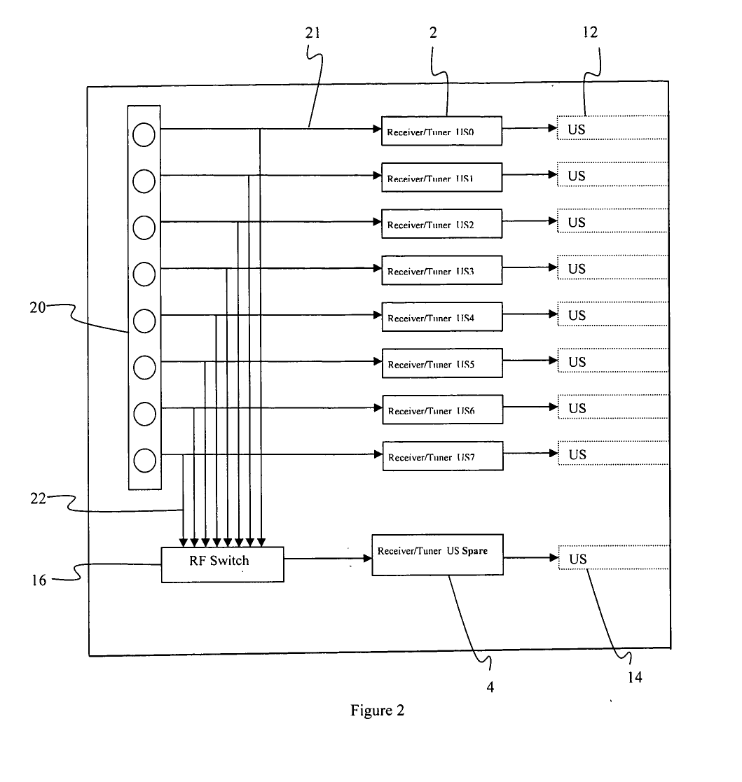

FIG. 2 illustrates the spare receiver 4 tapped into each of primary receiver ports 2 (e.g. R0-R7) in a non-intrusive manner. As illustrated, CMTS receiver ports 20, which may be in the form of Amphenol connectors, are provided to allow cables, e.g. coaxial cables, (not shown) to be connected with primary receivers 2. As also illustrated, signals from the headend are preferably provided through ports 20 to receivers 2 and demodulators 12.

Spare receiver 4 preferably taps into signal lines 21 of primary receiver ports 20 via signal lines 22, and the taps are preferably located where the cable signal comes from receiver ports 20 into the receivers 2 so both the connected primary receiver 2 and the spare receiver 4 may receive the same signal. Those of skill in the art will appreciate that each of the primary receivers 2 (e.g. receivers R0-R7) receive signals according to different communication characteristics, e.g. communication on a different frequency (RF band) and communication protocols. Spare receiver 4 is preferably tunable to the RF bands of each of the primary receivers 2. Preferably, the spare receiver 4 connects (matrices) with only one primary receiver 2 at a time.

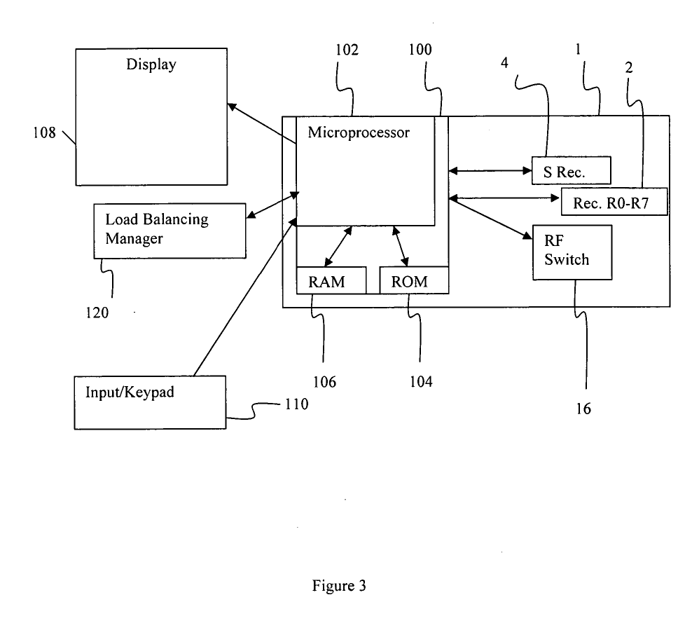

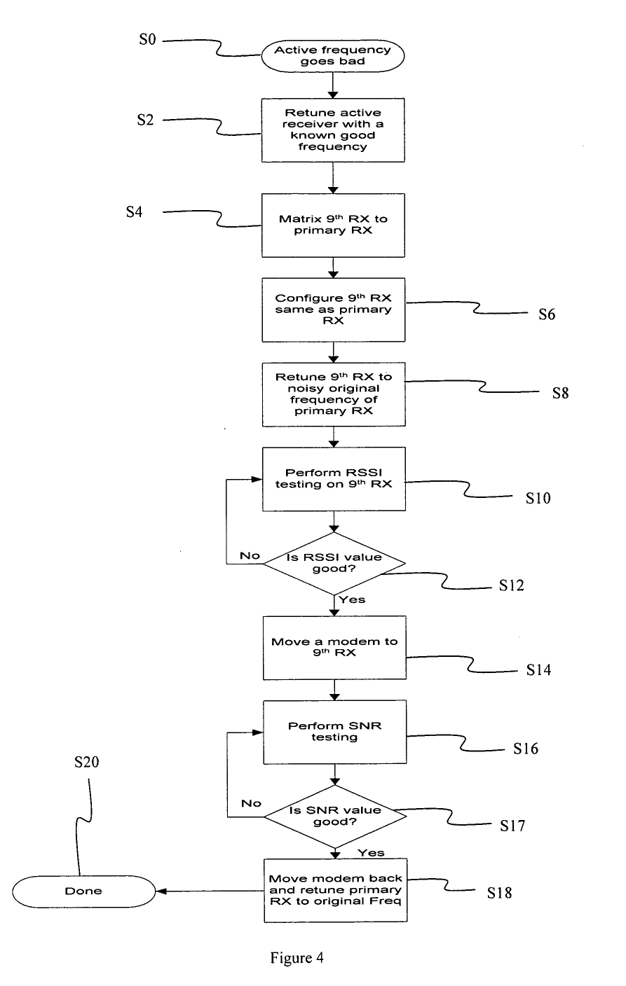

FIG. 3 illustrates an exemplary processing unit 100 contained in the CMTS. Processing unit 100 preferably contains a microprocessor 102 which may receive information, such as instructions and data, from a ROM 104 or RAM 106. Processing unit 100 is preferably connected to a display 108, such as a CRT or LCD display, which may display status information such as whether a receiver is in the same Load Balancing Group or Spectrum Group as another selected primary receiver. An input keypad 110 may also be connected to processing unit 100 and may allow an operator to provide instructions, processing requests and/or data to processor 100. Microprocessor 102 is preferably configured to provide instructions to RF switch 16 (FIG. 2) to select a primary receiver and modem borrowed in accordance with the processes illustrated in FIG. 4. Microprocessor 102 is also preferably configured to configure spare receiver 4 to match the communication characteristics of the selected primary receiver. The communication characteristics of each receiver 2 may be stored on ROM 104 or RAM 106, or may be provided from an external source, such as the headend. RAM 104 and/or ROM 106 may also carry instructions for microprocessor 102 to perform the processes illustrated in FIG. 4.

A load balancing manager module 120 also preferably operates with microprocessor 102. The load balancing manager module 120 may be a software implementation running within microprocessor 102 or may be operated on another component connected to microprocessor 102. Microprocessor 102 preferably is configured to select an appropriate modem for use as a testing modem and to determine the type of modem and protocols associated with moving the selected testing modem to the spare receiver.

FIG. 4 illustrates an exemplary process to rollback a receiver to its original channel frequency without interrupting service to a subscriber in accordance with the principles of the invention. As illustrated in FIG. 4, when an active receiver frequency goes bad, such as having a substantial amount of noise to interfere with the communications, step S0, the receiver is preferably retuned to a different frequency, preferably one which is known to be sufficiently free of noise, step S2. The spare, or 9^{th} receiver in an eight receiver set, is matriced (connected) to the primary receiver which was retuned to a cleaner frequency, a.k.a. the troubled receiver, by switch 16. As illustrated in step S8 the tunable spare receiver is preferably configured to the same communication parameters as the troubled primary receiver, including being configured to communication characteristics of the same RF band and communication protocols (e.g. MAP data) utilized by the selected RF receiver being analyzed. The spare receiver is preferably tuned to the original frequency of the troubled receiver, e.g. the noisy frequency, step S8.

The spare receiver, being tuned to the original frequency performs testing operations on the channel of the original frequency, such as a received signal strength indicator (RSSI) measurements without disruption of service. The RSSI testing preferably provides an indication of a noise floor of the channel frequency, e.g. if the channel frequency contains excessive noise modems may deregister. The techniques to perform RSSI measurements are well known to those of skill in the art. If the channel does not provide a suitable RSSI measurement, step S12, the process continues to obtain the measurements. The RSSI measurement process could be stopped after a predetermined period of time, or may be intermittently stopped for periods of time. When the RSSI measurement becomes acceptable, step S12, YES, a modem is moved to the spare receiver, step S14. The modem may be associated with the troubled receiver, or any other modem capable of communicating with the spare receiver as it is configured. Preferably, the modem selected (or borrowed) is currently inactive, e.g. not passing data or voice communications.

The modem may be moved to the spare receiver by a load balancing manager (e.g. a software task) according to a UCC or DCC protocol. The load balancing manager 120 preferably issues the UCC or DCC message to the modem sending it the ID of the spare receiver as its destination and/or sending initial maintenance (IM) and station maintenance (SM) requests. Once the modem retunes to the spare receiver it may be determined whether the testing modem is ranging correctly on the spare receiver to determine if the modem is appropriately communicating with the spare receiver. Preferably, the both the channel width and the frequency of the modem are not changed at the same time since some cable modems cannot handle this and will deregister. Preferably, the primary receiver information is stored by microprocessor 102 so the process can return the testing modem to its original primary receiver when the testing is finished.

The modem (a.k.a. the testing modem) which is moved to the spare receiver is preferably used to further test the original frequency channel of the troubled receiver, such as by performing signal to noise ratio (SNR) testing, step S16. Those of skill in the art will appreciate that any suitable type of testing may be performed which indicates the quality of the channel. The SNR testing preferably continues if a suitable SNR value is not obtained, step S17, NO. The testing process with the modem could be stopped after a predetermined period of time, or may be intermittently stopped for periods of time. When the testing determines that a suitable channel quality exists, e.g. a suitable SNR value exists, step S16, YES, the testing is completed. At the completion of the testing, the process is preferably reversed and the load balancing task moves (instructs the modem to retune to frequency of its original receiver) the testing modem moves back to its original receiver using the same protocol used to move it to the spare receiver. The troubled receiver is also retuned to its original channel frequency, step S18, and the process ends, step S20. Once the testing modem is back on its original receiver the testing process is finished.

During the moving process (and all the while it is registered on the spare receiver) the CMTS preferably sends to the testing modem both IM and SM messages to keep it registered on the spare receiver. During this time it is possible for any modem connected to the RF of the primary receiver of the testing modem to register on the spare receiver because the spare receiver is tapped into the primary receiver's RF signals. To prevent other unwanted modems from registering on the spare receiver an upstream override process may be performed on these modems to redirect them to the primary receiver or another receiver. Preferably, the only modem allowed to be registered on the spare receiver during a testing operation is the testing modem.

Those of skill in the art will appreciate that since the active receivers are not required to be used for testing, the process illustrated in FIG. 4 is non-intrusive to the cable network, and may be performed without causing a loss or disruption of service to subscribers. Even voice calls over the cable network should not be affected by any of the testing described above.

The processes in FIG. 4 may be implemented in hard wired devices, firmware or software running in a processor. A processing unit for a software or firmware implementation is preferably contained in the CMTS. The processes illustrated in FIG. 4 may be contained on a computer readable medium which may be read by microprocessor 102. A computer readable medium may be any medium capable of carrying instructions to be performed by a microprocessor, including a CD disc, DVD disc, magnetic or optical disc, tape, silicon based removable or non-removable memory, packetized or non-packetized wireline or wireless transmission signals.

Those of skill in the art will appreciate that the present invention enables cable operators to confidently return receivers to their intended frequencies without loss of service to subscribers, allowing the cable operators better management of their systems.

Those of skill in the art will appreciate that other modifications may be implemented without departing from the scope and spirit of the invention. For example, a plurality of testing procedures may be used with a borrowed modem moved to the spare receiver, and a plurality of modems may be borrowed to repeat a testing procedure.

1. An apparatus for frequency rollback for receivers in a network having a plurality of receivers, each receiver being capable of receiving signals according to frequency channels from a plurality of modems, the apparatus comprising:
a switching unit which selectively connects a spare receiver to a signal line associated with one of the plurality of receivers, enabling the spare receiver to receive signals sent to a selected one of the plurality of receivers from a modem registered with the selected one of the plurality of receivers; and
a controller configured to instruct the switching unit to connect the spare receiver with a communication line of a troubled receiver of the plurality of receivers which has been tuned to a frequency channel different than an original frequency channel of the troubled receiver, configured to tune a modem to the spare receiver as a testing modem, and configured to perform testing of the original frequency using the testing modem.

2. The apparatus of claim 1, wherein the controller is further configured to retune the troubled receiver back to its original frequency when the testing determines that the signal quality of the original frequency is sufficient.

3. The apparatus of claim 1, wherein the controller is further configured to perform receive signal strength indicator testing prior to tuning the testing modem to the spare receiver.

4. The apparatus of claim 1, wherein the controller determines the signal quality of the original frequency without deregistering the testing modem.

5. The apparatus of claim 1, wherein the signal quality of the original frequency is determined using a signal to noise ratio test.

6. A method for performing a frequency rollback for receivers in a network having a plurality of receivers, each receiver being capable of receiving signals according to frequency channels from a plurality of modems, the method comprising the steps of:
connecting a spare receiver to a signal line associated with a troubled receiver which has been tuned to a different frequency than an original frequency of the troubled receiver;
configuring the spare receiver to have a communication characteristics which correspond to communication characteristics of the troubled receiver;
tuning the spare receiver to the original frequency of troubled receiver;
testing a signal quality of the original frequency using the spare receiver; and
retuning the troubled receiver to the original frequency when the signal quality of the original signal is determined to be suitable.

7. The method of claim 6, wherein the step of testing the signal quality of the original frequency includes performing receive signal strength indicator testing by the spare receiver.

8. The method of claim 6, wherein the step of testing the signal quality of the receiver includes the steps of:
tuning a modem to communicate with the spare receiver; and
performing testing on the original frequency using the modem and the spare receiver.

9. The method of claim 8, wherein the testing performed by the modem and the spare receiver is signal to noise ratio testing.

10. A computer readable medium containing instructions for a processor to perform a method of frequency rollback for receivers in a network having a plurality of receivers, each receiver being capable of receiving signals according to frequency channels from a plurality of modems, the method comprising the steps of:
connecting a spare receiver to a signal line associated with a troubled receiver which has been tuned to a different frequency than an original frequency of the troubled receiver;
configuring the spare receiver to have a communication characteristics which correspond to communication characteristics of the troubled receiver;
tuning the spare receiver to the original frequency of troubled receiver;
testing a signal quality of the original frequency using the spare receiver; and
retuning the troubled receiver to the original frequency when the signal quality of the original signal is determined to be suitable.

11. The computer readable medium of claim 6, wherein the step of testing the signal quality of the original frequency includes performing receive signal strength indicator testing by the spare receiver.

12. The computer readable medium of claim 6, wherein the step of testing the signal quality of the receiver includes the steps of:
tuning a modem to communicate with the spare receiver; and
performing testing on the original frequency using the modem and the spare receiver.

13. The computer readable medium of claim 8, wherein the testing performed by the modem and the spare receiver is signal to noise ratio testing.
